(19) United States
(12) Patent Application Publication
(10) Pub. No.: US 2026/0213931 A1
(43) Pub. Date: Jul. 23, 2026

(54) QUANTUM DISTRIBUTION METHODS AND ASSOCIATED TELECOMMUNICATIONS DEVICES

(71) Applicant: THALES, MEUDON (FR)

(72) Inventor: Yann OSTER, TOULOUSE (FR)

(21) Appl. No.: 19/138,621

(22) PCT Filed: Nov. 16, 2023
(86) PCT No.: PCT/EP2023/082133

§ 371 Date: Jun. 12, 2025

(30) Foreign Application Priority Data
Dec. 15, 2022 (FR) FR2213411

(51) Int. Cl. H04L 9/08

(52) U.S. Cl. CPC H04L 9/0852

(57) ABSTRACT

A quantum key distribution method for quantum distribution of a key, referred to as K_{QKD_N}, to two telecommunications devices (D_ALICE, D_BOB), each connected to a quantum channel and connected to one another by a classical channel, includes: communicating, on the quantum channel, a random sequence of bits in the form of a sequence of light pulses; communicating parity bits on the classical channel; and correcting errors in the random sequence of bits on the basis of the communicated parity bits; determining the key K_{QKD_N} on the basis of the random sequence of bits, the key being shared between the devices; wherein the communication of the parity bits is encrypted or decrypted on the basis of at least one key K_{QKD_N-k} determined beforehand by prior implementation of a QKD quantum key distribution mechanism for quantum key distribution to the devices.

### CROSS-REFERENCE TO RELATED APPLICATIONS

This application is a National Stage of International patent application PCT/EP2023/082133, filed on Nov. 16, 2023, which claims priority to foreign French patent application No. FR 2213411, filed on Dec. 15, 2022, the disclosures of which are incorporated by reference in their entireties.

### FIELD OF THE INVENTION

The invention lies in the field of symmetric secret key generation and sharing between two remote telecommunications devices associated with their respective users, who will be called Alice and Bob below: Alice and Bob's devices must use a strictly identical key to be able to encrypt/decrypt their messages. The invention relates more specifically to quantum key distribution (QKD) and the underlying communication of information such as parity bits or choices of bases used or selection of measurements retained.

### BACKGROUND

Quantum cryptography is based on the transmission of qubits (quantum bits) or randomly generated coherent states, with a view to creating and distributing secret keys able to be used by classical encryption protocols such as one-time pad encryption. Since the first protocol proposed in 1984 (BB84), multiple QKD protocols have been defined. A distinction is made between discrete-variable protocols (qubits, DV-QKD) and continuous-variable protocols (CV-QKD). Some protocols (BB84, DV-QKD) are based on random choices of a generation and measurement basis (or quadrature), and involve the communication of these choices of bases. Other protocols (CV-QKD with a heterodyne receiver) do not involve communications regarding the choice of a measurement basis. Some protocols based on photon entanglement involve a photon source external to Alice and Bob's devices. However, all QKD protocols incorporate a residual error correction step with a view to creating a shared key between Alice and Bob, involving the communication of parity bits, for various error correction and detection techniques (FEC codes (forward error correction codes) such as LDPC (low-density parity code), interactive and iterative protocols such as Cascade or Winnow, etc.). For illustrative purposes, reference will be made below to the BB84 protocol.

In a quantum cryptography protocol, the two remote parties Alice and Bob possess:
quantum objects, that is to say physical objects that behave according to the laws of quantum physics; in practice, these objects are light pulses in a quantum regime (photons), which may take multiple forms: single photons, coherent states, entangled photon pairs, etc.; the photon makes it possible to encode information on observable variables such as the polarization of light, its frequency, its phase etc.;
a quantum channel, allowing light pulses to transit;
a classical communication channel (also referred to as a public channel, typically using the Internet, radio waves, fiber-optic transmission or free-space transmission).

Quantum key distribution (QKD) is a technique that exploits quantum properties to guarantee randomness, making it possible to detect the interception and retransmission, by a malicious third party, which we will call Eve (Eavesdropper), of an initial message generated by Alice and intended for Bob. Since it is impossible to clone unknown quantum information without it being destroyed, or to measure an unknown quantum state without modifying it, the reading of qubits during transmission thereof between two parties wishing to encrypt their communications with a secret key derived from these qubits by an intruder is able to be detected immediately: an interception will be detected immediately by Alice and Bob's devices, who will renounce this key.

One reference QKD technique is the BB84 protocol published by C. Bennett and G. Brassard in 1984 and using discrete variables: qubits. A qubit takes a value of 0 or 1, and is represented by the polarization of a single photon, on two possible quadratures (bases): H/V or D/A (the upper-case H, V, D, A indicates the type of polarization: H for horizontal, V for vertical, D for diagonal and A for antidiagonal).

The main steps of quantum key distribution are as follows:
Alice's device generates a sequence of random bits and encodes each bit on each light pulse, and then transmits it to Bob's device through the quantum channel.
Bob's device then measures the information carried by the pulse that it has received.
Alice and Bob's devices evaluate a level of interception of the information exchanged on the quantum channel based on the differences between the transmitted data and those measured and, if the level is greater than a fixed threshold, the quantum distribution operation is terminated.
Otherwise, the secret key is extracted from the correlated data via what is referred to as a data reconciliation step: in this reconciliation step, a bit string shared by Alice and Bob's devices is determined from the correlated data and using an error correction algorithm implementing parity bits.
A secrecy-amplification step is generally implemented to neutralize information leakage during reconciliation.

For each qubit (0/1) of a series of qubits generated randomly by Alice's device, Alice's device generates, on the quantum channel, a photon whose polarization depends on the random choice of a quadrature (H/V or D/A) and on the binary value in question (0/1).

At the other end of the quantum channel, on the reception side, Bob's device randomly selects, for each qubit, a quadrature to carry out the detection (either on H/V or on D/A). Any qubit measured on the same quadrature as the quadrature used at transmission is normally transmitted correctly: 100% to within ε. (the value of ε is typically in the range [0; 10%]). When the Tx/Rx quadratures are not identical, the probability of the transmission being incorrect is 50% to within ε.

After transmission, Bob's device therefore has a set of measurements that are correlated with the data sent by Alice's device, but the information in which might have been spied on by Eve.

What is referred to as the reconciliation phase then takes place, using only the classical communication channel, in which:
what is referred to as a sifting step selects the transmitted qubits for which Alice and Bob's devices use the same generation and detection quadrature: for this purpose, Alice and Bob's devices communicate without encryption on the classical channel to disseminate the quadratures used, either symmetrically and explicitly, or asymmetrically with one party disseminating its quadratures used and then the other party determining and disseminating the selection of qubits retained (identical Tx/Rx quadratures); this makes it possible to create two versions of a key, referred to as a sifted key, on Alice's and Bob's side, respectively, by discarding on average 50% of qubits (different Tx/Rx quadratures);
the error rate is estimated in order to determine the potential presence of Eve (case of the key being rejected), and to select an error correction code (choice of the code and rate) or to parameterize an interactive and iterative request/response-based error correction protocol for the remainder of the processing;
a step of detecting and correcting residual errors, comprising exchanges, on the classical channel, of parity bits computed by Alice and/or Bob's devices on their respective sifted key then takes place (Cascade or Winnow protocol, FEC LDPC error correction code, etc.), following which Alice and Bob's devices share a strictly identical key, for which Eve possesses a certain amount of information.

Alice and Bob's devices then share a secret key (after an additional secrecy-amplification step). The concept of a “shared key” is understood to mean that the key is common to Alice and Bob.

The dissemination, on the public channel, of information shared between Alice and Bob's devices (side information) concerning the values of the parity bits and the choices of bases used (or possibly relating to the selection of qubits that are retained), in the reconciliation phase, constitutes a harmful information leak that could help Eve in her search for the key. This disclosure jeopardizes the secrecy of the key, and requires secrecy-amplification processing, at the expense of reducing the size of the key.

Indeed, knowing the choice of bases used for each qubit, Eve knows which qubits are reliable (to within 1-ε) out of those that she has measured. Based on the reliable qubits, and knowing the (reliable) parity values and the residual error correction method, Eve is able to deduce values of other qubits, either in terms of value or in terms of probability. In any case, this information disseminated on the public channel makes it possible to reduce the key exploration combinatorics for Eve. The only known way to avoid this is secrecy-amplification processing, implementing hash functions to combine the elements of the key, at the expense of reducing key size.

There is therefore a need for a quantum key distribution solution that makes it possible to better preserve secrecy and to reduce the risk of information leakage on the public channel.

### SUMMARY OF THE INVENTION

Thus, according to a first aspect, the present invention describes a quantum key distribution method for quantum distribution of a key, referred to as K_{QKD_N}, to a first and second telecommunications device with a view to implementing, between them, telecommunications encrypted by said key K_{QKD_N},
said first and second telecommunications devices each being connected to a respective first telecommunications link and connected to one another by a second telecommunications link,
said first link being an optical transmission link and being referred to hereinafter as a quantum channel, said second telecommunications link being referred to hereinafter as a classical channel;
said method comprising the following steps for determining K_{QKD_N}, implemented by at least one device in question out of the first and second devices:
   communicating, on the quantum channel, a random sequence of bits in the form of a sequence of light pulses in a quantum regime such that, for each light pulse of the sequence of pulses, a physical parameter of each light pulse encodes the value of at least one of said bits of the random sequence of bits; said sequence of bits being stored by each of the first and second devices;
   communicating, on the classical channel, between the first and second devices, information indicating parity bit values, said parity bit values having been computed by at least one of said first and second devices on the basis of the random sequence of bits that it has stored, and then being transmitted, in said communication, to the other of said first and second devices, which then carries out error correction in the sequence of bits stored by the other of said first and second devices, on the basis of said transmitted parity bits;
   determining said key K_{QKD_N} on the basis of said random sequence of bits, and storing said key K_{QKD_N}, said key being shared between said first and second devices;
said method being characterized in that said communication of information indicating parity bit values between the first and second devices is encrypted or decrypted by said device in question on the basis of at least one key K_{QKD_N-k} determined beforehand by prior implementation of a QKD quantum key distribution mechanism for quantum key distribution to said first and second devices.

The proposed solution greatly reduces information leakage and improves the level of secrecy. There is no unencrypted transmission (or transmission with public key encryption) of choice of bases used, and/or of information relating to parities on the public channel. This sensitive information is encrypted beforehand based on at least one secret key generated beforehand through QKD via the quantum channel and the classical channel in a prior step.

The use of a key obtained through QKD guarantees unconditional security with respect to the computing power of a third party (Eve).

Eve is not able to access the information regarding the choice of bases used (jointly by Alice and Bob's devices) and regarding the selection of qubits retained, or the information relating to the parity bits. This is because, although Alice and Bob's devices share these secret keys generated beforehand and are therefore able to encrypt/decrypt messages carrying information regarding the choice of bases, the selection of qubits and parities, this is not the case for Eve.

This makes it possible to greatly reduce the leakage of information regarding the key.

Eve possesses a sequence of qubits, without being able to identify which ones are correct (on average 75% of the sequence) and which ones are retained to form the key.

According to a second aspect, the present invention describes a quantum key distribution method for quantum distribution of a key, referred to as K_{QKD_N}, to a first and second telecommunications device with a view to implementing, between them, telecommunications encrypted by said key K_{QKD_N},
said first and second telecommunications devices each being connected to a respective first telecommunications link and connected to one another by a second telecommunications link,
said first link being an optical transmission link and being referred to hereinafter as a quantum channel, said second telecommunications link being referred to hereinafter as a classical channel;
said method comprising the following steps for determining K_{QKD_N}, implemented by at least one device in question out of the first and second devices:
communicating, on the quantum channel, a random sequence of bits in the form of a sequence of light pulses in a quantum regime such that, for each light pulse of the sequence of pulses, a physical parameter of each light pulse encodes the value of at least one of said bits of the random sequence of bits; said sequence of bits being stored by each of the first and second devices;
communicating, on the classical channel, between the first and second devices, information relating to bases, indicating, for each bit of the stored sequence, the basis, out of at least two distinct coding bases for coding between values of said parameter and the values 0 or 1 of a bit of the random sequence of bits, that at least one of the first and second devices has randomly selected to carry out the encoding between the bit and the value of said light pulse parameter;
said device selecting those bits of the random sequence of bits for which the first and second devices have selected the same bases;
communicating, on the classical channel, between the first and second devices, information indicating parity bit values, said parity bit values having been computed by at least one of said first and second devices on the basis of said selected bits, and then being transmitted, in said communication, to the other of said first and second devices, which then carries out error correction, on the basis of said transmitted parity bits, on the bits selected by the other of said first and second devices;
determining said key K_{QKD_N} on the basis of the selected bits and of the error correction, and storing said key K_{QKD_N}, said key being shared between said first and second devices;
said method being characterized in that said communication of information relating to said bases between the first and second devices is encrypted or decrypted by said device in question on the basis of at least one key K_{QKD_N-k} determined beforehand by prior implementation of a QKD quantum key distribution mechanism for quantum key distribution to said first and second devices.

In some embodiments of such a method, said communication of information indicating parity bit values between the first and second devices is furthermore encrypted or decrypted by said device in question on the basis of at least one key KQ_{KD_N-k} determined beforehand by the implementation of a prior iteration of a QKD quantum key distribution method for quantum key distribution to said first and second devices.

In some embodiments of a method according to the first aspect or the second aspect of the invention, at least one of the following provisions is implemented:
the information is encrypted or decrypted on the basis of a symmetric encryption or decryption key determined by way of concatenation and permutation and/or logical combination operations carried out on the bits of at least one key determined beforehand by QKD quantum key distribution to said first and second devices;
said information used for QKD reconciliation, encrypted or decrypted on the basis of at least the key K_{QKD_N-k} determined beforehand, is random and mutually independent information.

According to a third aspect, the invention describes a computer program intended to be stored in the memory of a telecommunications device and furthermore comprising a microcomputer, said computer program comprising instructions that, when they are executed on the microcomputer, orchestrate the steps of a method according to the first or second aspect of the invention.

According to a fourth aspect, the invention describes a telecommunications device designed to be connected to a first telecommunications link, designed to be connected to another telecommunications device by a second telecommunications link, and to implement, with said other device, telecommunications encrypted by a key K_{QKD_N},
said first link being an optical transmission link and being referred to hereinafter as a quantum channel, said second telecommunications link being referred to hereinafter as a classical channel; said device being designed to determine K_{QKD_N} by:
communicating, on the quantum channel, a random sequence of bits in the form of a sequence of light pulses in a quantum regime such that, for each light pulse of the sequence of pulses, a physical parameter of each light pulse encodes the value of at least one of said bits of the random sequence of bits; said sequence of bits being stored by the device;
communicating, on the classical channel, with the other device, information indicating parity bit values, said parity bit values having been computed by at least one first device out of said device and said other device on the basis of the random sequence of bits that it has stored, and then being transmitted, in said communication, to the second out of said device and said other device, which then carries out error correction in the sequence of bits stored by the other of said first and second devices, on the basis of said transmitted parity bits;
determining said key K_{QKD_N} on the basis of said random sequence of bits, and storing said key K_{QKD_N}, said key being shared between said device and said other device;
said device being characterized in that said communication of information indicating parity bit values between said device and said other device is encrypted or decrypted by said device on the basis of at least one key K_{QKD_N-k} determined beforehand by prior implementation of a QKD quantum key distribution mechanism for quantum key distribution to said device and to said other device.

According to a fifth aspect, the invention describes a telecommunications device designed to be connected to a first telecommunications link, designed to be connected to another telecommunications device by a second telecommunications link, and to implement, with said other device, telecommunications encrypted by a key KQKD_N,
said first link being an optical transmission link and being referred to hereinafter as a quantum channel, said second telecommunications link being referred to hereinafter as a classical channel; said device being designed to determine K_{QKD_N} by:
   communicating, on the quantum channel, a random sequence of bits in the form of a sequence of light pulses in a quantum regime such that, for each light pulse of the sequence of pulses, a physical parameter of each light pulse encodes the value of at least one of said bits of the random sequence of bits; said sequence of bits being stored by the device;
   communicating, on the classical channel, with the other device, information indicating, for each bit of the stored sequence, the basis, out of at least two distinct coding bases for coding between values of said parameter and the values 0 or 1 of a bit of the random sequence of bits, that a first device out of said device and said other device has randomly selected to carry out the encoding between the bit and the value of said light pulse parameter;
   selecting those bits of the random sequence of bits for which said device and said other device have selected the same bases;
   communicating, on the classical channel, between said device and said other device, information indicating parity bit values, said parity bit values having been computed by a first device out of said device or said other device on the basis of said selected bits, and then being transmitted, in said communication, to the second device out of said device and said other device, which then carries out error correction, on the basis of said transmitted parity bits, on the bits selected by the second device out of said device and said other device;
   determining said key K_{QKD_N} on the basis of the selected bits, and storing said key K_{QKD_N}, said key being shared between said device and said other device;
said device being characterized in that said communication of information relating to said bases between said device and said other device is encrypted or decrypted by said device on the basis of at least one key K_{QKD_N-k} determined beforehand by prior implementation of a QKD quantum key distribution mechanism for quantum key distribution to said device and to said other device.

In some embodiments, a telecommunications device according to the fifth aspect of the invention is designed to encrypt or decrypt said communication of information indicating parity bit values between said and said other device on the basis of at least one key KQ_{KD_N-k} determined beforehand by prior implementation of a QKD quantum key distribution to said device and to said other device.

In some embodiments, a telecommunications device according to the fourth or fifth aspect of the invention is designed to encrypt or decrypt the information on the basis of a symmetric encryption or decryption key determined by concatenation and permutation and/or logical combination operations carried out on the bits of at least one key determined beforehand by QKD quantum key distribution to said first and second devices (D_ALICE, D_BOB).

### BRIEF DESCRIPTION OF THE DRAWINGS

The invention will be better understood and other features, details and advantages will become more clearly apparent on reading the non-limiting description that follows, and by virtue of the appended figures, which are given by way of example.

FIG. 1 schematically shows a QKD key generation system in one embodiment of the invention;

FIG. 2 shows the steps of a quantum key distribution method in one embodiment of the invention;

FIG. 3 illustrates the transmission and detection of a sequence of qubits in one embodiment of the invention;

FIG. 4 is a table illustrating the implementation of a method in one embodiment of the invention, at start-up;

FIG. 5 is a table illustrating the implementation of a method in one embodiment of the invention, in steady state.

Identical references may be used in various figures to designate identical or comparable elements.

### DETAILED DESCRIPTION

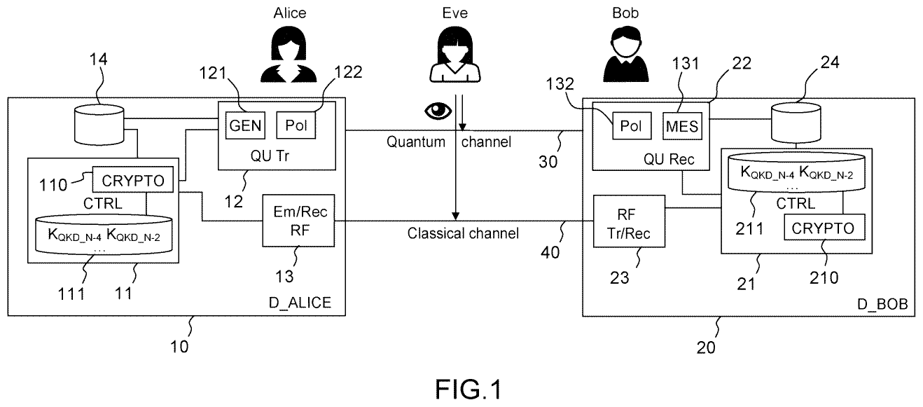

FIG. 1 shows a QKD symmetric key generation system in one embodiment of the invention, comprising two telecommunications devices 10, 20 connected to one another by a quantum channel 30 and a classical channel 40. Each, or one, of the telecommunications devices 10, 20 is for example on the ground or housed on board a satellite, an aircraft, etc.

The quantum channel 30 is a telecommunications channel that allows the transit of information (binary in DV-QKD or continuous in CV-QKD) carried by a physical property of a quantum object (for example polarization of a photon) transmitted on this channel; here, the quantum channel 30 is designed to transmit light pulses (generated by a photon source, transmission being carried out on a fiber-optic optical link or simply by free propagation through the open air, the atmosphere, space, etc.).

The classical channel 40 is a standard communication channel, for example (for example a radiofrequency link, the Internet, an optical fiber, etc.), assumed to be accessible to all in unencrypted form (including a malicious third party Eve) in order to allow the telecommunications devices 10 and 20 to converge on the definition of a secret key on the basis of transmitted qubits, as described below for the BB84 protocol.

The telecommunications device 10, hereinafter called D_ALICE, belonging to a user Alice, comprises a control unit 11, a quantum transmission unit 12, a radiofrequency (RF) transmission/reception unit 13 and a memory 14. The control unit 11 comprises a cryptography unit 110 and a memory 111 associated with the cryptography unit 110 and storing secret keys generated beforehand through a QKD method between D_ALICE 10 and D_BOB 20.

The telecommunications device 20, hereinafter called D_BOB, belonging to a user Bob, comprises a control unit 21, a quantum reception unit 22, a radiofrequency (RF) transmission/reception unit 23 and a memory 24. The control unit 21 comprises a cryptography unit 210 and a memory 211 associated with the cryptography unit 210 and storing secret keys generated beforehand through QKD between D_ALICE 10 and D_BOB 20.

The radiofrequency (RF) transmission/reception units 13 and 23 are designed to communicate with one another via the classical channel 40.

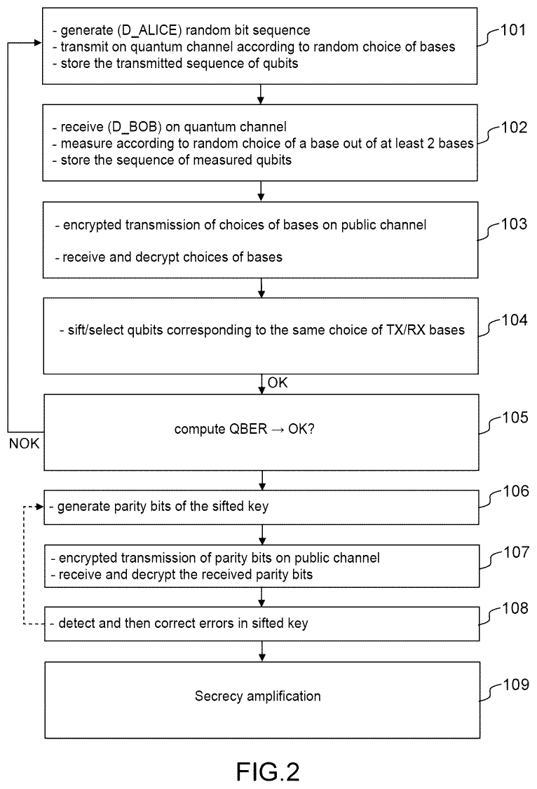

The control unit 11, respectively 21, comprises for example a memory and a microprocessor (neither shown). In one embodiment, the memory of the control unit 11, respectively 21, comprises software instructions that, when they are executed on the microprocessor of the control unit 11, respectively 21, implement the steps incumbent on the control unit 11, respectively 21, and described below, notably with reference to FIG. 2.

The radiofrequency (RF) transmission/reception unit 13, respectively 23, typically comprises a modem and a radiofrequency transmit and receive antenna (neither shown).

The quantum transmission unit 12 comprises a generation unit, called GEN 121, and a polarization unit, called Pol 122.

The unit GEN 121 is designed to randomly generate a sequence of bits to be transmitted.

The unit Pol 122 is designed to randomly choose, for each bit to be transmitted, a basis from a set of bases comprising multiple reference polarization bases (these bases are also called modes or quadratures), and to transmit a light pulse with a polarization corresponding to the value of the bit to be transmitted in the randomly chosen basis for this bit.

The unit Pol 122 comprises for example a polarization rotator capable of rotating the polarization of the emitted light signal selectively by 0° (if the H/V basis is chosen by the unit Pol 132) or by 45° (if the D/A basis is chosen), the selection between the angles 0° and 45° being made randomly. For example, the polarization rotator is produced with a half-wave retardation plate rotated by an actuator. Another embodiment uses an electro-optic polarization modulator, designed for high rates of polarization change.

All of the bases, in this case, comprise two bases, for example:
a first horizontal/vertical (H/V) basis, in which “1” is encoded by a photon with a 0° polarization axis and “0” is encoded by a photon with a 90° polarization;
a second diagonal/antidiagonal (D/A) basis, in which “0” is encoded by a photon with a 45° polarization axis and “1” is encoded by a photon with a 135° polarization.

The quantum reception unit 22 comprises a polarization unit, called Pol 132, and a measuring unit 131.

Before the expected arrival of a photon, the unit Pol 132 is designed to perform a polarization rotation in order to randomly choose a basis out of the two H/V and D/A bases. The unit Pol 132 comprises a polarization rotator capable of rotating the polarization of the emitted light signal selectively by 0° (if the H/V basis is chosen by the unit Pol 132) or by 45° (if the D/A basis is chosen). For example, the polarization rotator is produced with a half-wave retardation plate rotated by an actuator.

The measuring unit 131 is designed to measure two quadrature light polarization components at the output of the polarization rotator Pol 132, either on the H/V basis if the polarization rotation is 0° or on the D/A basis if the polarization rotation is 45°. For example, the measuring unit is formed with a polarizing beam splitter (PBS) that generates a quadrature, and two single-photon detectors (SPD) for the two components of the quadrature.

It will be recalled here that a photon may be polarized along any axis. A photon polarized along an axis of angle ‘a’ passing through a polarizing filter along an axis of angle ‘b’ has a probability equal to cos²(b−a) of passing through the polarizing filter, according to Malus' law.

According to the quantum properties used by quantum cryptography:
when the probability of passing through the filter is neither 0 nor 1, the passage of an individual photon through the filter is fundamentally unpredictable and indeterministic;
the polarization axis is able to be known only by using a polarizing filter (or more generally, by carrying out a measurement the result of which is YES or NO) and with a large number of measurements to estimate the probability of passage; there is no direct measurement on an individual photon that gives an angle, for example, of the polarization axis of the photon.

The steps of a QKD method according to the invention will now be described with reference to FIG. 2.

The initial context is as follows: Alice wishes to exchange an Nth message, called M_N, with Bob. To do this, a secret key, K_{QKD_N}, must be generated through QKD, in a manner shared between D_ALICE 10 and D_BOB 20, so as to allow one of them to encrypt and the other to decrypt this Nth message, which will be able to be transmitted with maximum security. For her part, Eve is attempting to intercept the communications in order to determine the key. In accordance with Kerckhoff's principles (worst-case hypothesis), it is assumed for example that Eve has access to the communication channels used by D_ALICE 10 and D_BOB 20, that she has full knowledge of the protocol used, and has unlimited computing means. The security of the encrypted communications between D_ALICE 10 and D_BOB 20 is then provided solely by the secret key that the method described below generates and distributes.

### Quantum Phase

Generally speaking, only this phase uses the quantum channel, and the post-processing phase does not use it.

### Step 101

In this step 101:
in response to a corresponding command from the control unit 11 to the unit GEN 121, the unit GEN 121 randomly generates a sequence of 2T bits, which thus take the value 0 or 1; T is an integer typically greater than 10000;
following the receipt of a respective command from the control unit 11 to the unit Pol 122, the unit Pol 122 randomly chooses, for each generated bit, a polarization basis out of the two polarization bases and emits, on the quantum channel 30, photon by photon, a photon whose polarization depends on the value of the generated bit and on the polarization basis chosen for this qubit; each photon is emitted at regular intervals. The qubits are thus transmitted.

The sequence of choice of bases and bits corresponding to the generated sequence of qubits is then stored by the control unit 11 in the memory 14 and the value of each bit is stored therein, in association with the polarization basis chosen for the bit by the unit Pol 122 and with the rank of the bit in sequence and.

### Step 102

Under the control of the control unit 21, before the expected arrival of each photon, the unit Pol 132 randomly chooses a basis (by modifying the orientation of a rotator or by modifying the control of a polarization modulator). At the expected time of arrival of a photon, under the control of the control unit 21, the measuring unit 131 measures what is leaving the polarizing filter on the selected components. The control unit 21 determines the value of the bit corresponding to the detected photon on the basis of the measurement carried out and of the basis chosen for the measurement (corresponding to the polarization rotation carried out by the unit Pol 132) and stores, in the memory 24, for each detected photon, the determined value of the bit in association with the chosen basis and the reception rank of the photon (and therefore of the qubit).

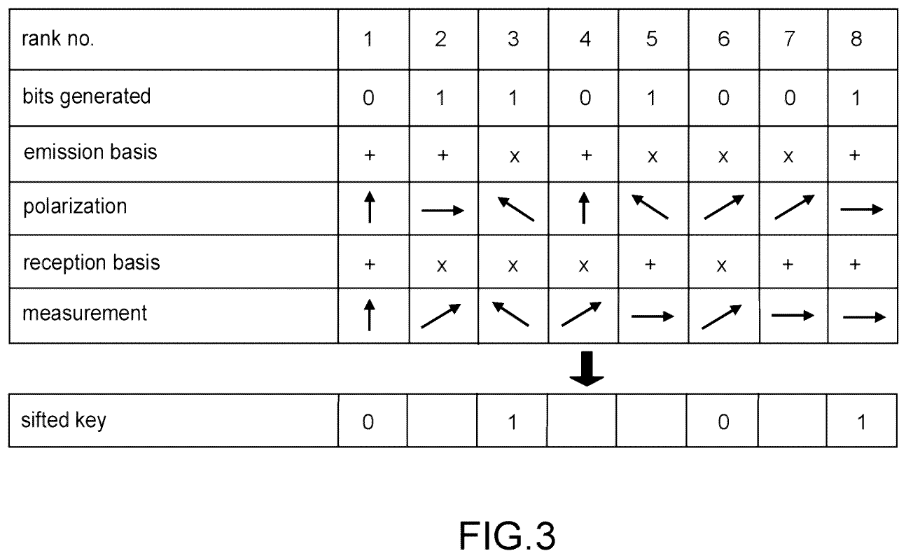

FIG. 3 shows, in a table, the rank number of the first 8 bits of a sequence generated in step 101 (first row of the table) and the randomly generated value for these bits (second row). These bits thus take the following values: 0 for the bit of rank 1, 4, 6 and 7, and 1 for the bit of rank 2, 3, 5 and 8.

The third row indicates the basis chosen for the transmission of each bit by the device D_ALICE 10: the sign “+” indicates that the H/V basis was chosen, while the sign “x” indicates that the D/A basis was chosen. Thus, for the bits of rank 1, 2, 4 and 8, the H/V basis was chosen, and the D/A basis was chosen for the bits of rank 3 and 5 to 7.

The fourth row indicates the polarization of the emitted photon: vertical for the bit of rank 1 and 4, horizontal for the bit of rank 2 and 8, diagonal for the bit of rank 6 and 7, antidiagonal for the bits of rank 3 and 5.

The fifth row of the table indicates the basis chosen by the device D_BOB 20, at reception: H/V for the photon received at rank 1, 5, 7 and 8, and D/A for the photon of rank 2, 3, 4 and 6.

Finally, the sixth row illustrates the result of the measurement by the device D_BOB 20: for the photons of rank 1, 3, 6, 8, the measurement basis corresponds to the emission basis and the polarization of the detected photon generally corresponds to the polarization at emission of the photon; for the photons of rank 2, 4, 5, 7, the measurement basis is different from the emission basis and the polarization of the detected photon is totally random. The determined value of the qubit stored in the memory 24 is 0 for the photon of rank 1 and 6 and is 1 for the photon of rank 3 and 8.

### Post-Processing Phase

### Step 103

In a step 103:
in the controller 21 of the device D_BOB 20, the binary sequence {bases}_{Bob}, which is stored in the memory 24, successively defining the polarization basis chosen to detect each photon of the sequence received in step 102, is supplied as input to the cryptography unit 210; for example, if the set of bases comprises only the two H/V and D/A bases, in the binary sequence indicating the choice of bases, a “0” (respectively a “1”) at rank n of this sequence {bases}_{Bob} will indicate that the H/V (respectively D/A) basis was used to detect the qubit of rank n in the step in question (step 102);
the cryptography unit 210 carries out encryption using at least one of the secret keys stored in the memory 211 and generated beforehand through QKD by D_ALICE 10 and D_BOB 20, this binary sequence indicating the chosen bases;
the controller 21 of the device D_BOB 20 then transmits, to the device D_ALICE 10, via the RF transmission/reception unit 23 and on the classical channel 40, the binary sequence thus encrypted indicating the polarization basis chosen to detect each photon of the sequence received in step 102;
the controller 11 of the device D_ALICE 10 receives, via the RF transmission/reception unit 13, the encrypted binary sequence {bases}_{Bob}, which is then processed by the cryptography unit 110; the latter decrypts it using those one or more secret keys stored in the memory 111 that was or were used to encrypt this sequence.

### Step 104 (Sifting)

The controller 11 then compares, for each rank in the sequence of qubits, the chosen polarization basis received on the classical channel 40 and the polarization basis associated with this rank that is stored in the memory 14 of the device 10; it selectively retains (sifting step) only the qubits that were generated (D_ALICE 10) and measured (D_BOB 20) on the same basis. Statistically, only 50% of the bits are retained.

The list of indexes of the only qubits retained is then provided as input to the cryptography unit 110, which encrypts it using at least one of the secret keys stored in the memory 111 and generated beforehand through QKD by D_ALICE 10 and D_BOB 20. The controller 11 of the device D_ALICE 10 then transmits, to the device D_BOB 20, via the RF transmission/reception unit 13 and on the classical channel 40, the thus-encrypted list of the qubits retained.

The controller 21 of the device D_BOB 20 receives, via the RF transmission/reception unit 23, the encrypted list of indexes retained and provides it to the cryptography unit 210; the latter decrypts it using those one or more secret keys stored in the memory 211 that was or were used to encrypt this sequence.

The controller 21 of the device D_BOB 20 in turn selectively retains, out of all of the qubits received in step 102, only the qubits whose index (that is to say rank in the sequence transmitted by D_ALICE/received by D_BOB) is indicated in the received list, these being the qubits generated (D_ALICE 10) and measured (D_BOB 20) on the same basis.

The qubits thus retained by D_ALICE 10, D_BOB 20 form their respective sifted key.

All of these retained qubits were transmitted to D_BOB 20 with a probability of 1-ε, that is to say to within noise-induced errors, adjustment/synchronization defects and implementation imperfections. Sifting has made it possible to discard qubits detected on a basis other than the generation basis, the transmission of these qubits being unreliable (at 50%: therefore random).

In the example of FIG. 3, the bits of rank 1, 3, 6 and 8 are thus the only ones retained by D_ALICE 10 and D_BOB 20, out of the first eight bits of the sequence, for the rest of the steps (cf. row “sifted key”).

(It should be noted that, in alternative embodiments of steps 103 and 104, the roles of D_ALICE 10 and D_BOB 11 are swapped or else each of D_ALICE 10 and D_BOB 11 transmits its choices of basis to the other and then compares, for each rank in the sequence of qubits, the chosen polarization basis received on the classical channel 40 and the polarization basis associated with this rank, which is stored in the memory of the device 10, respectively 20; it selectively retains (sifting step) only the qubits that were generated (D_ALICE 10) and measured (D_BOB 20) on the same basis.)

### Step 105

The control units 11 and 21 then evaluate the qubit transmission error rate (QBER, quantum bit error rate) affecting their respective sets of bits retained in sifting step 104, in order to detect potential interception by Eve, to evaluate the amount of information intercepted by Eve on the quantum channel during the transmission in step 101 and to potentially select, depending on the evaluated error rate, an error correction code (choice of code and rate) or to parameterize a request/response-based iterative error correction protocol for the remainder of the processing. For this purpose, a certain number of qubits are “sacrificed”, since they are communicated on the classical channel 40: these are also discarded from the bits retained by the control units 11 and 21 for the remainder of the post-processing. After elimination of the qubits used to estimate the QBER, the sifted key consists of t qubits.

Based on the comparison between this error rate evaluation and a given threshold (determining whether a third party listened to the quantum channel during the transmission of the qubits or whether an unacceptable amount of information was intercepted), this distribution operation is terminated (and may then be reinitiated from step 101); otherwise, step 106 is implemented.

Due to the limitations of photon sources and photon detectors and implementation, adjustment or synchronization imperfections, the bits of the sifted key retained at this stage by D_ALICE and D_BOB are not generally perfectly identical. The below set of steps 106-108 of the reconciliation phase aims to detect/correct residual errors in the qubits of the sifted key determined respectively by D_ALICE and D_BOB, using a forward error correction code (FEC), or else an interactive and iterative request/response protocol between Alice and Bob, in order to determine and transmit parity bits associated with subgroups (that is to say packets) of the qubits of the sifted key, in order to detect/correct residual errors between Alice's key and Bob's key, and so that they then have a strictly identical key.

Redundant parity information is then generated either by D_ALICE 10 or by D_BOB 20 or both, and then transmitted by either.

As described below, these parities are transmitted via the public channel to the other party, so that said other party is able to identify residual errors on one sifted key relative to the other (D_ALICE/D_BOB), in accordance with the error detection and correction protocol retained, on the basis of the received parities and its own sifted key.

### Step 106

In one embodiment, in a step 106, each control unit 11, 21, in parallel with one another, computes parity bits from subgroups of the t bits of the sifted key after estimation of the error rate QBER in step 105, on the basis of the error detection and correction protocol retained (a Cascade or Winnow iterative protocol here).

The values of the parity bits computed by each control unit 11, respectively 21, are stored in memory 14, 24.

### Step 107

One of the cryptography units 110, respectively 210, encrypts these parity values, using at least one of the secret keys stored in the memory 111, respectively 211 and generated beforehand through QKD by D_ALICE 10 and D_BOB 20.

To make the other device aware of the values of the computed parity bits, one of the control units 21, respectively 11, transmits the values of these parity bits thus encrypted on the classical channel 40 via the RF Tr/Rec units 23, respectively 13. One of the control units 11, respectively 21, receives, on the classical channel, the values of these parity bits thus encrypted and provides them to the cryptography unit 110, respectively 210, which decrypts them using those one or more secret keys stored in the memory 111, respectively 211, that was or were used to encrypt these values.

### Step 108

One of the control units 11, respectively 21, then compares the received value of each parity bit, which was computed for a given subgroup of bits, with the value that it computed itself for this same subgroup of bits of its own sifted key. With a Cascade or Winnow iterative protocol, the parity comparison makes it possible either to detect/correct an erroneous bit or to direct the error searching process, via a new parity computing request, to another subgroup of bits. The residual errors between the sifted key held by D_ALICE 10 and D_BOB 20 may thus be detected and corrected on the basis of this comparison carried out for each parity bit. Bits detected as being erroneous may be either corrected or discarded. This process makes it possible to obtain, in D_ALICE 10 and D_BOB 20, a secret key that is ideally strictly identical and shared between them of size v.

A Cascade or Winnow iterative protocol involves a variable number of requests/responses between D_ALICE 10 and D_BOB 20, depending on the number of residual errors; a forward error correction (FEC) code involves a single message sent by only one of the devices 10, 20 to the other of the devices 20, 10 to detect/correct residual errors. The exchanges take place on the public channel 40.

Steps 106, 107 and 108 above describe, by way of example, the case of a Cascade or Winnow iterative request/response protocol (computing of parity bits in the devices 10, 20, transmission by one device to the other, comparison in one device).

In the case of using an FEC code protocol, for example LDPC, depending on the embodiments:
the control unit of D_ALICE 11 computes for example the parity bits from the bits of Alice's sifted key (after sifting, step 104, and after estimation of the error rate QBER, step 105); these parities are transmitted in encrypted form to the control unit 21 of D_BOB 20, which decrypts them, and then decodes them with its sifted key version, in order to identify errors on its key (Bob); D_BOB 20 then corrects its errors; and/or
the control unit of D_BOB 21 computes for example the parity bits from the bits of Bob's sifted key; these parities are transmitted in encrypted form to the control unit 11 of D_ALICE 10, which decrypts them, and then decodes them with its sifted key version, in order to identify errors on its key (Alice); D_ALICE then corrects its errors.

Regardless of the error detection and correction protocol retained, the principle remains the same: transmitting encrypted information to the other device on the public channel in order to access the parity values.

### Step 109

A secrecy-amplification step, which is optional and may in any case be lightened compared to the prior art, implements hash functions with a view to combining the bits of the key obtained at the end of step 108 and thus reducing Eve's information regarding the final key, at the expense of reducing the size of the key. Hash functions are very difficult to reverse, and may be used to generate pseudo-random numbers. They often use modular arithmetic.

Example of a hash function:

$$\text{?}$$

$$\text{?} \text{indicates text missing or illegible when filed}$$

At the end of the implementation of the method according to the invention, D_ALICE 10 and D_BOB 20 possess a shared secret key, K_{QKD_N}, which they will then each use as a symmetric encryption key, one of them to encode and the other to decode the message M_N exchanged between them on the public channel or another channel. Each control unit 11, respectively 21, stores the QKD key thus newly generated, K_{QKD_N}, in the memory 111, 211, for a limited duration.

The size of K_{QKD_N} is equal to v (that is to say it comprises v bits, with v<t, v<T).

To improve the confidentiality of the QKD with respect to the transmission of the parities, of the bases used and possibly of the selection of qubits retained, QKD according to the invention is therefore used.

The security of (Vernam) secret key encryption is based on the use of a secret random key of at least the same size as the message to be encrypted, and the obligation not to reuse the key.

However, a key may be reused to encrypt any new random message, without compromising the security of previous transmissions with the same key. It is not common to encrypt perfectly random information (because it is meaningless).

This is exploited according to the invention for QKD reconciliation processing, to encrypt the information regarding the choice of bases, regarding the qubits selected and regarding the parities.

The random nature of a sequence is associated with statistical characteristics and may be estimated with a set of statistical tests (AIS 31, NIST SP 800-22, etc.). In practice, the mean of a binary sequence should be close to 0.5, the auto-correlation function should be free from peaks, entropy should be sufficient, etc.

The choice of bases used at transmission and at reception are defined by two independent (uncorrelated) and random binary sequences {bases}_{Alice} and {bases}_{Bob}: D_ALICE 10 and D_BOB 20 may therefore encrypt this information completely securely based on at least one previous secret key obtained through QKD without compromising the security of previous transmissions with this same key. The same applies when one party (D_BOB) disseminates its choices of bases and then the other party (D_ALICE) disseminates the selection of qubits retained: these sequences are random and independent, and D_ALICE 10 and D_BOB 20 are therefore able to encrypt this information completely securely based on at least one previous secret key obtained through QKD.

The information regarding the choice of bases of D_ALICE (or D_BOB) or regarding the selection of qubits retained, on the one hand, and the information regarding the parities, on the other hand, is random and mutually independent. Encryption thereof based on at least one and the same secret key therefore does not compromise the security of previous transmissions with this same key.

For example, the secret key K_{QKD_N-1} used to encrypt the (N−1)th message, called M_N−1, exchanged between D_ALICE 10 and D_BOB 20, may be reused to encrypt the information regarding Alice's choice of bases, along with the parity bits, when constructing the key K_{QKD_N}. The key K_{QKDN-2} used to encrypt the (N−2)th message, M_N−2, may be reused to encrypt the information regarding Bob's choice of bases to construct the key K_{QKD_N}, etc.

The sequence of bases used by D_ALICE, {bases}_{Alice}, is encrypted by D_ALICE 10 differently and independently, for each bit, of the encryption of the sequence {bases}_{Bob} by D_BOB 20: Eve thus cannot know which qubits will be discarded or retained during sifting.

Proceeding this way means that Eve cannot know:
which (indexes) qubits will be discarded/retained during sifting
the choice of bases for the qubits retained
the parity values.

Eve possesses only the raw sequence of qubits that she observed randomly (depending on the choice of bases), of which 75% of the content is statistically correct, and 50% will be discarded during sifting. She cannot perform sifting since she does not know which qubits are retained. No parity information allows her to restrict the search space of the candidate keys. Another example in the case of asymmetric dissemination of information regarding the choices of bases: the secret key K_{QKD_N-1} used to encrypt the (N−1)th message, called M_N−1, exchanged between D_ALICE 10 and D_BOB 20, may be reused to encrypt the information regarding the choice of bases by D_BOB, and then to encrypt the parity bits, when constructing the key K_{QKD_N}. The key K_{QKD_N-2} used to encrypt the (N−2)th message, M_N−2, may be reused by D_ALICE to encrypt the information regarding the selection of qubits retained to construct the key K_{QKD_N}, etc.

### Size of the Information (Chosen Bases, Parity Bits) to be Encrypted, Use of Secret Keys

The 2 sequences of qubits, respectively generated (step 101, that of D_ALICE) and received (step 102, that of D_BOB), that is to say considered before sifting, have a size 2T. Each of the two binary sequences defining the choices of bases used, {bases}_{Alice} and {bases}_{Bob}, have the same size. This size is equal to 2T when only two bases are contained in the set of bases. The size is greater than 2T when more than one bit is needed to identify the chosen basis (that is to say in cases where D_ALICE 10 and D_BOB 20 choose their basis from a set of bases comprising a number of bases strictly greater than two).

The 2 sequences after sifting have a variable size t close to T, the sifting discarding on average 50% of the qubits transmitted by D_ALICE. The 2 sequences after estimation of the error rate QBER (step 105) have a size u smaller than t.

The sequence of parities has a possibly variable size, which may for example be considered to be smaller than 2T, the invention also being suitable for sequences to be encrypted of a size greater than 2T.

Finally, after amplification of the secrecy (step 109), each secret key has a size v strictly smaller than u, t and T.

Symmetric key encryption of these various sequences (choice of bases, selection of qubits retained, parity bits) therefore requires keys of sizes 2T. It is nevertheless possible to use secret keys of a size smaller than T.

One conventional approach consists in using an encryption algorithm using a key of a size independent of that of the message, which is conditional upon the availability/distribution of keys for D_ALICE and D_BOB.

However, for better protection, another solution consists in using the Vernam one-time pad cipher, in reusing secret keys obtained through QKD, notably by combining them by carrying out concatenation, permutation and/or logical combination operations (XOR or exclusive operator) on the bits, so as to form larger keys for encrypting the information regarding Alice and/or Bob's choices of bases, regarding the selection of qubits retained and regarding the parities.

Encrypting D_BOB and D_ALICE's choice of bases differently and independently for each qubit has the effect that Eve is not able to determine which qubits are retained/rejected during sifting. Permutations between or within the secret keys that are used make it possible to meet this need. The 2 bits of symmetric encryption keys used to encrypt D_ALICE's and D_BOB's choice of basis relating to each qubit must thus be independent (uncorrelated).

Since the parity information is independent of the (random) choice of bases and the selection of qubits retained and relates to random information (random sequence to form a key), one and the same secret encryption key may be used to encrypt this information (choice of basis by a single party, that is to say either D_ALICE or D_BOB, selection of the qubits retained and parity information), without compromising the security of this key.

This applies to the transient state, after having generated at least one secret key through QKD, and to the steady state, which corresponds to the generation of at least k secret keys (that is to say k=3 for encrypting binary sequences of size 2T) through QKD.

### Initialization of the Method

When a QKD session is started between D_ALICE 10 and D_BOB 20, they then do not always store previously shared secret keys generated through QKD in their respective memory 111, 211.

It is possible to use multiple options to initiate the mechanism according to the invention, for example those described below.

Option A (Wait to have the Required Number of Previous Keys to Carry Out Encryption on the Classical Channel)

It is sufficient to use QKD, in line with classical methods, to generate the required number of keys, for example three (or more) keys, for example K_{QKD_1}, K_{QKD_2}, K_{QKD_3}, without encrypting the information on choice of bases, selection of qubits retained, and parities transmitted on the classical channel. Each key K_{QKD_1}, respectively K_{QKD_2}, K_{QKD_3}, makes it possible to encrypt a payload message M_1, respectively M_2, M_3 (which is a priori meaningful, that is to say not a random sequence). Next, during the phase of creating the QKD key K_{QKD_n}, for example for n>3 when, according to the method of the invention, at least three previously generated keys, for example K_{QKD_n-1}, K_{QKD_n-2}, K_{QKD_n-3}, are used to generate, through combination (permutation/concatenation/logical combination carried out on the bits), the encryption keys for the sequences of choice of bases, selection of qubits retained and parity from steps 103, 104, 107.

### Option B (Produce the Required Number of Previous Keys Before Starting to Encrypt Payload Messages and on the Classical Channel)

Same as option A, but without using the keys to encrypt payload messages (meaningful messages), for greater security, as long as the transmissions of the basis and parity sequences are not encrypted in accordance with the invention.

### Option AB, Intermediate (Reuse at Least One Previous Key to Form Keys of Size 2T to Encrypt the Classical Channel)

According to this intermediate option, by using one of the previous options to generate a first secret key, it is possible to reuse this (the secret key) multiple times to encrypt the information regarding the choice of bases, the selection of qubits retained and the parities, until a sufficient number of secret keys have been generated to implement the general method described with reference to FIG. 2 (the method may, however, be implemented based on a secret key obtained through QKD; the required/optimum number of keys to encrypt the side information corresponds to an additional level of confidentiality). When the selection of qubits retained is not communicated, it is then desirable to perform at least one permutation of the secret key to encrypt each bit of the choice of bases for D_ALICE 10 and D_BOB 20 differently and independently, so that Eve is not able to determine which qubits are retained/rejected. In a final intermediate step, various secret keys may be used to encrypt the information regarding the choice of bases, the selection of qubits retained and the parities, one of which is reused in this encryption.

Accessibility to the information regarding the choice of bases, the selection of qubits retained and the parities thus changes rapidly as new keys are produced, until it becomes inaccessible to Eve.

As described, D_ALICE 10 and D_BOB 20 keep a register, in the memories 111, 211, of the last secret keys used during the session. This allows them to secretly generate (by encrypting sensitive information) new secret keys.

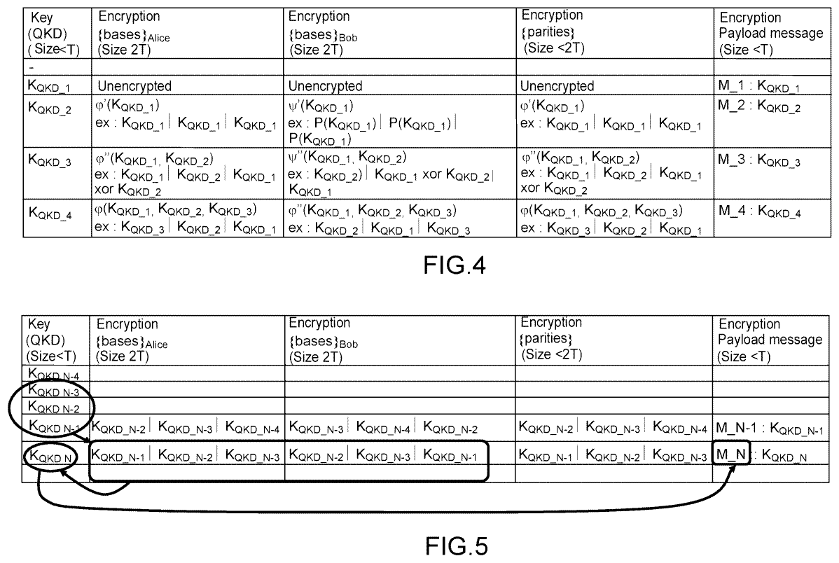

The table of FIG. 4 illustrates the transient state at start-up, in one embodiment of the invention, with the use of one or more previous QKD secret keys to encrypt the information on the choice of bases used by D_ALICE 10 and D_BOB 20 and the parity information.

The table of FIG. 5 illustrates, this time, in one embodiment of the invention, in steady state, the use of previous secret keys to form secret keys of size 2T to encrypt the information regarding the choice of bases used by D_ALICE 10 and D_BOB 20, and to encrypt the parity information.

Each row in these tables corresponds to the step of constructing a QKD key, of size u smaller than T and indicated in the left-hand column. The cell in the second column indicates how, during this construction, the sequence {bases}_{Alice} of size 2T is encrypted (or not), and the cell in the third column indicates how, during this construction, the sequence {bases}_{Bob} of size 2T is encrypted (or not). The cell in the fourth column indicates how, during this construction, the sequence of parity bits of size smaller than 2T is encrypted (or not) (in the error detection protocol in question here, only D_ALICE 10 transmits the parity bits to D_BOB 20, D_BOB not sending them). Finally, the rightmost column of the table indicates the payload message that will be transmitted in encrypted form by the key once it has been constructed: the message M_i is thus encrypted by the key K_{QKD_i}, i=1, 2, 3, . . . N−1, N, etc. The size of the message M_i is smaller than or equal to the size of K_{QKD_i}.

With reference to FIG. 4:

During the QKD protocol-based creation of the first session key, K_{QKD_1}, the sequences of bases chosen and parity values are transmitted in unencrypted form. At the end of this construction, the key K_{QKD_1} is used to encrypt a first payload message, M_1, exchanged between D_ALICE 10 and D_BOB 20.

The second key K_{QKD_2} is generated by encrypting the transmissions on the classical channel, using sequences derived from the first secret key (concatenation, logical combination, permutations of the bits). For example, during the QKD protocol-based creation of the second session key, K_{QKD_2}:
the sequence of bases {bases}_{Alice} is encrypted on the basis of the key K_{QKD_1}; for example, a concatenation function φ′ is applied to the key K_{QKD_1} to generate an encryption key for the sequence of choice of bases with a size greater than or equal to 2T; for example, it concatenates the key K_{QKD_1} 3 times: K_{QKD_1}|K_{QKD_1}|K_{QKD_1};
the sequence of bases {bases}_{Bob} is encrypted on the basis of the key K_{QKD_1}, but separately and independently (at the level of each bit) compared to {bases}_{Alice}; for example, a function ψ′ combining permutation and concatenation is applied to the key K_{QKD_1} to generate an encryption key of size greater than or equal to 2T; for example, it permutes (P) the bits in K_{QKD_1} and then concatenates the permuted key 3 times: P(K_{QKD_1})|P(K_{QKD_1})|P(K_{QKD_1});
the sequence of parities is for example encrypted with the same encryption key as for the sequence {bases}_{Alice}.

At the end of the construction of K_{QKD_2}, the key K_{QKD_2} is used to encrypt a second payload message, M_2, exchanged between D_ALICE 10 and D_BOB 20.

A similar procedure is used to generate the third secret key K_{QKD_3}, this time using concatenations of the first QKD secret keys K_{QKD_1} and K_{QKD_2} to encrypt the choices of bases and the parity values.

After the generation of K_{QKD_3}, a transition takes place to steady state.

With reference now to FIG. 5, the focus is on the generation of the key K_{QKD_N} in one embodiment of the invention, with N greater than or equal to 4, the previously generated QKD keys being stored by D_ALICE 10 and D_BOB 20.

During the method for generating K_{QKD_N} in one mode of implementation of the invention, sequentially:
a set of the last secret keys shared by D_ALICE 10 and D_BOB 20 (here the last 3 K_{QKD_N-3}, K_{QKD_N-2}, and K_{QKD_N-1}) is used for example to construct, by concatenation, encryption keys of a size sufficient to encrypt (decrypt) the sequences of binary information relating to the bases used by D_ALICE, by D_BOB and to encrypt the parities;
a permutation on the keys concatenated by D_BOB with respect to D_ALICE is performed in order to hide which qubits are retained/discarded during sifting from Eve: thus, for example, in the present case, the symmetric encryption key used to encrypt (decrypt) {bases}_{Alice} (and the parity bits) is K_{QKD_N-1}|K_{QKD_N-2}|K_{QKD_N-3}, while the symmetric encryption key used to encrypt (decrypt) {bases}_{Bob} is K_{QKD_N-2}|K_{QKD_N-3}|K_{QKD_N-1}.

Next, the key K_{QKD_N} is used to encrypt an Nth payload message, M_N, exchanged between D_ALICE 10 and D_BOB 20.

Iterations are carried out to generate the successive secret keys.

Only the payload message is meaningful. The other sequences are independent and random at the level of each bit.

The protection of the information exchanged during reconciliation (choice of bases used, selection of qubits retained, parities) is improved by using a larger number of previous secret keys. FIGS. 4 and 5 show the use of up to 3 previous keys to create any new QKD key. The principle may of course be transposed to the use of any number of previous keys to encrypt the various sequences during reconciliation.

Considering, in one exemplary implementation of the invention, a random sequence of bits to be encrypted indicating the information on the choice of basis or the selection of the qubits retained, or else the parity bits, on the one hand, and an encryption key of a size (in terms of number of bits) greater than the sequence to be encrypted, on the other hand, one example of encryption, carried out by the cryptography unit 110, 210, of the sequence with the encryption key is to perform an EXCLUSIVE OR operation between the bit of the sequence of rank n and the bit of rank n of the encryption key, for any value of n ranging from 1 to the size of the sequence.

Generally speaking, all QKD protocols have the common property of implementing reconciliation and error correction processes to generate two identical keys from raw keys (qubits transmitted on the quantum channel). The invention proposed here is applicable to all QKD protocols, independently of the encoding mode (for example polarization-based/phase-based/etc.) and variants of these protocols.

The invention has notably been described above with reference to the transmission of random binary information based on photon polarization, for example within the framework of the BB84 protocol; however, the invention is applicable to any QKD symmetric key generation protocol (for example E91, B92, etc.) and system, including discrete-variable QKD protocols, with other physical parameters used to encode bits on qubits, for example the frequency or phase of a photon, optionally differentially (frequency-coded QKD or phase-coded QKD or differential phase-coded QKD; where phase is used, the encoding relies on a phase modulator instead of a polarization rotator/modulator) instead of or in addition to photon polarization, protocols using continuous variables (GG02), and/or using the transmission of multiple photons per light pulse, etc.

Similarly, although consideration has been given above to an example of encoding a single bit per photon, the invention also applies in the case where a parameter of the photon transmitted on the quantum channel encodes multiple bits, on the basis for example of protocols for encoding multiple bits per light pulse, such as the GG02, GMCS Gaussian Modulated Coherent-States protocols.

In the exemplary embodiment described above, the encryption is implemented on the sequences of choices of bases, on the sequences of selection of qubits retained and the sequences of parity values; in some embodiments, only the sequences of choices of bases or selection of qubits retained or only the sequences of parity values are encrypted.

Moreover, the invention may also be implemented in embodiments without a random choice of basis used at reception and/or at transmission, such as for example in a differential phase-coded QKD protocol; the residual error correction step is then nevertheless still necessary.

The invention may also be implemented in embodiments in which the QKD protocol employed uses photon polarization to encode the bits, but with a number of states considered different from the four states considered in BB84: for example, BB92 uses 2 polarizations, SSP uses 6.

The steps incumbent on the control unit 11, 21 and described above may be implemented by executing software instructions on a processor. Alternatively, they may be implemented by dedicated hardware, typically a digital integrated circuit, which is either specific (ASIC) or based on programmable logic (for example FPGA/field-programmable gate array).

The term “bit” designates the binary information itself (“0” or “1”), the term “qubit” designates this binary information more specifically when it is carried by a quantum state of an elementary particle, in particular a photon (that is to say generation and polarization in the device 10, propagation in the quantum channel and measurement in the device 20); however, in the above description, one or the other of the two terms may have been used without distinction to designate the corresponding binary information.

It should be noted that the random choice of the polarization basis, both at transmission and at reception, may be made in various ways: as described below, with a polarization modulator or by mechanical switching of a polarization rotator controlled by a quantum random generator, a beam splitter such as a semi-reflecting plate, a fixed polarization rotator such as a half-wave plate, etc., using known techniques.

Moreover, in some embodiments, the QKD protocol that is implemented is based on entanglement (for example E91 protocol) for which photons are generated by a source that may be external to D_ALICE and D_BOB. In this case, D_ALICE does not generate the binary sequence: D_ALICE and D_BOB receive this sequence and are like 2 receivers that agree with one other on the decoding of the sequence of qubits received, with random choices of basis (A and B) (or not), in accordance with steps 102 et seq. described above.

1. A quantum key distribution method for quantum distribution of a key, referred to as K_{QKD_N}, to a first and second telecommunications device (D_ALICE, D_BOB) with a view to implementing, between them, telecommunications encrypted by said key K_{QKD_N},
said first and second telecommunications devices (D_ALICE, D_BOB) each being connected to a respective first telecommunications link and connected to one another by a second telecommunications link,
said first link being an optical transmission link and being referred to hereinafter as a quantum channel, said second telecommunications link being referred to hereinafter as a classical channel;
said method comprising the following steps for determining K_{QKD_N}, implemented by at least one device in question out of the first and second devices:
communicating, on the quantum channel, a random sequence of bits in the form of a sequence of light pulses in a quantum regime such that, for each light pulse of the sequence of pulses, a physical parameter of each light pulse encodes the value of at least one of said bits of the random sequence of bits; said sequence of bits being stored by each of the first and second devices;
communicating, on the classical channel, between the first and second devices, information indicating parity bit values, said parity bit values having been computed by at least one of said first and second devices on the basis of the random sequence of bits that it has stored, and then being transmitted, in said communication, to the other of said first and second devices, which then carries out error correction in the sequence of bits stored by the other of said first and second devices, on the basis of said transmitted parity bits; and
determining said key K_{QKD_N} on the basis of said random sequence of bits, and storing said key K_{QKD_N}, said key being shared between said first and second devices; said method wherein said communication of information indicating parity bit values between the first and second devices is encrypted or decrypted by said device in question on the basis of at least one key K_{QKD_N-k} determined beforehand by prior implementation of a QKD quantum key distribution mechanism for quantum key distribution to said first and second devices.

2. A quantum key distribution method for quantum distribution of a key, referred to as K_{QKD_N}, to a first and second telecommunications device (D_ALICE, D_BOB) with a view to implementing, between them, telecommunications encrypted by said key K_{QKD_N},
said first and second telecommunications devices (D_ALICE, D_BOB) each being connected to a respective first telecommunications link and connected to one another by a second telecommunications link,
said first link being an optical transmission link and being referred to hereinafter as a quantum channel, said second telecommunications link being referred to hereinafter as a classical channel;
said method comprising the following steps for determining K_{QKD_N}, implemented by at least one device in question out of the first and second devices:
communicating, on the quantum channel, a random sequence of bits in the form of a sequence of light pulses in a quantum regime such that, for each light pulse of the sequence of pulses, a physical parameter of each light pulse encodes the value of at least one of said bits of the random sequence of bits; said sequence of bits being stored by each of the first and second devices;
communicating, on the classical channel, between the first and second devices, information relating to bases, indicating, for each bit of the stored sequence, the basis, out of at least two distinct coding bases for coding between values of said parameter and the values 0 or 1 of a bit of the random sequence of bits, that at least one of the first and second devices has randomly selected to carry out the encoding between the bit and the value of said light pulse parameter;
said device selecting those bits of the random sequence of bits for which the first and second devices have selected the same bases;
communicating, on the classical channel, between the first and second devices, information indicating parity bit values, said parity bit values having been computed by at least one of said first and second devices on the basis of said selected bits, and then being transmitted, in said communication, to the other of said first and second devices, which then carries out error correction, on the basis of said transmitted parity bits, on the bits selected by the other of said first and second devices; and
determining said key K_{QKD_N} on the basis of the selected bits and of the error correction, and storing said key K_{QKD_N}, said key being shared between said first and second devices;
said method wherein said communication of information relating to said bases between the first and second devices (D_ALICE, D_BOB) is encrypted or decrypted by said device in question on the basis of at least one key K_{QKD_N-k} determined beforehand by prior implementation of a QKD quantum key distribution mechanism for quantum key distribution to said first and second devices.

3. The quantum key distribution method as claimed in claim 2, wherein said communication of information indicating parity bit values between the first and second devices (D_ALICE, D_BOB) is furthermore encrypted or decrypted by said device in question on the basis of at least one key KQ_{KD_N-k} determined beforehand by the implementation of a prior iteration of a QKD quantum key distribution method for quantum key distribution to said first and second devices.

4. The quantum key distribution method as claimed in claim 1, wherein the information is encrypted or decrypted on the basis of a symmetric encryption or decryption key determined by way of concatenation and permutation and/or logical combination operations carried out on the bits of at least one key determined beforehand through QKD quantum key distribution to said first and second devices (D_ALICE, D_BOB).

5. The quantum key distribution method as claimed in claim 1, wherein said information used for QKD reconciliation, encrypted or decrypted on the basis of at least the key K_{QKD_N-k} determined beforehand, is random and mutually independent information.

6. A computer program, intended to be stored in the memory of a telecommunications device (D_ALICE, D_BOB) and furthermore comprising a microcomputer, said computer program comprising instructions that, when they are executed on the microcomputer, orchestrate the steps of a method as claimed in claim 1.

7. A telecommunications device (D_ALICE, D_BOB) designed to be connected to a first telecommunications link, designed to be connected to another telecommunications device (D_ALICE, D_BOB) by a second telecommunications link, and to implement, with said other device, telecommunications encrypted by a key K_{QKD_N}, said first link being an optical transmission link and being referred to hereinafter as a quantum channel, said second telecommunications link being referred to hereinafter as a classical channel; said device being designed to determine K_{QKD_N} by:
communicating, on the quantum channel, a random sequence of bits in the form of a sequence of light pulses in a quantum regime such that, for each light pulse of the sequence of pulses, a physical parameter of each light pulse encodes the value of at least one of said bits of the random sequence of bits; said sequence of bits being stored by the device;
communicating, on the classical channel, with the other device, information indicating parity bit values, said parity bit values having been computed by at least one first device out of said device and said other device on the basis of the random sequence of bits that it has stored, and then being transmitted, in said communication, to the second out of said device and said other device, which then carries out error correction in the sequence of bits stored by the other of said first and second devices, on the basis of said transmitted parity bits; and
determining said key K_{QKD_N} on the basis of said random sequence of bits, and storing said key K_{QKD_N}, said key being shared between said device and said other device; said device (D_ALICE, D_BOB) wherein said communication of information indicating parity bit values between said device and said other device is encrypted or decrypted by said device on the basis of at least one key K_{QKD_N-k} determined beforehand by prior implementation of a QKD quantum key distribution mechanism for quantum key distribution to said device and to said other device (D_ALICE, D_BOB).

8. A telecommunications device (D_ALICE, D_BOB) designed to be connected to a first telecommunications link, designed to be connected to another telecommunications device (D_ALICE, D_BOB) by a second telecommunications link, and to implement, with said other device, telecommunications encrypted by a key K_{QKD_N}, said first link being an optical transmission link and being referred to hereinafter as a quantum channel, said second telecommunications link being referred to hereinafter as a classical channel; said device being designed to determine K_{QKD_N} by:
communicating, on the quantum channel, a random sequence of bits in the form of a sequence of light pulses in a quantum regime such that, for each light pulse of the sequence of pulses, a physical parameter of each light pulse encodes the value of at least one of said bits of the random sequence of bits; said sequence of bits being stored by the device;
communicating, on the classical channel, with the other device, information indicating, for each bit of the stored sequence, the basis, out of at least two distinct coding bases for coding between values of said parameter and the values 0 or 1 of a bit of the random sequence of bits, that a first device out of said device and said other device has randomly selected to carry out the encoding between the bit and the value of said light pulse parameter;
selecting those bits of the random sequence of bits for which said device and said other device have selected the same bases;
communicating, on the classical channel, between said device and said other device, information indicating parity bit values, said parity bit values having been computed by a first device out of said device or said other device on the basis of said selected bits, and then being transmitted, in said communication, to the second device out of said device and said other device, which then carries out error correction, on the basis of said transmitted parity bits, on the bits selected by the second device out of said device and said other device; and
determining said key K_{QKD_N} on the basis of the selected bits, and storing said key K_{QKD_N}, said key being shared between said device and said other device;
said device wherein said communication of information relating to said bases between said device and said other device (D_ALICE, D_BOB) is encrypted or decrypted by said device on the basis of at least one key K_{QKD_N-k} determined beforehand by prior implementation of a QKD quantum key distribution mechanism for quantum key distribution to said device and to said other device.

9. The telecommunications device (D_ALICE, D_BOB) as claimed in claim 8, wherein said communication of information indicating parity bit values between said and said other device (D_ALICE, D_BOB) is furthermore encrypted or decrypted by said device on the basis of at least one key K_{QKD_N-k} determined beforehand by prior implementation of a QKD quantum key distribution to said device and to said other device (D_ALICE, D_BOB).

10. The telecommunications device (D_ALICE, D_BOB) as claimed in claim 7, wherein the information is encrypted or decrypted on the basis of a symmetric encryption or decryption key determined by way of concatenation and permutation and/or logical combination operations carried out on the bits of at least one key determined beforehand through QKD quantum key distribution to said device and to said other device (D_ALICE, D_BOB).
